(19) United States
(12) Patent Application Publication
(10) Pub. No.: US 2023/0025433 A1
(43) Pub. Date: Jan. 26, 2023

(54) OSCILLATING WINDING WEIGHT WITH A DECORATIVE ELEMENT FOR AN AUTOMATIC TIMEPIECE MOVEMENT

(71) Applicant: The Swatch Group Research and Development Ltd, Marin (CH)

(72) Inventor: Benjamin CHARTREL, St-Blaise (CH)

(73) Assignee: The Swatch Group Research and Development Ltd, Marin (CH)

(21) Appl. No.: 17/784,709

(22) PCT Filed: Oct. 15, 2020
(86) PCT No.: PCT/EP2020/079065

§ 371 Date: Jun. 13, 2022

(30) Foreign Application Priority Data
Dec. 18, 2019 (EP) 19217731.9

(51) Int. Cl. G04B 5/16; G04B 45/02

(52) U.S. Cl. CPC G04B 5/165; G04B 45/02

(57) ABSTRACT

An oscillating winding weight of a movement of a timepiece is mounted such that it rotates on an arbor of the movement. The oscillating winding weight comprises a main element conferring the overall shape of the oscillating winding weight, a heavy part allowing the weight to oscillate in response to the movement of the timepiece and the force of gravity, and a decorative element. The decorative element is a logo or initials and attached to the main element. The main element comprises a first material, the decorative element comprises a second material, and the heavy part comprises a third material. The third material has a higher density than the second material, such that the heavy part is heavier than the decorative element in order to position the decorative element in a predefined position.

### FIELD OF THE INVENTION

The present invention relates to an oscillating winding weight provided with a decorative element for a movement of an automatic-movement timepiece. More particularly, the invention relates to such a winding weight with which a wristwatch including a transparent back is intended to be fitted.

### BACKGROUND OF THE INVENTION

Wristwatches having cases with transparent backs to allow the movement thereof to be observed are already known. However, when such watches include an automatic winding movement, the observation of the movement is always diminished by the presence of the oscillating winding weight which, even when openworked, as is the case in so-called “skeleton” watches, prevents comfortable observation of the movement.

In order to overcome this problem, the European patent No. 0 957 414 proposes an oscillating winding weight comprising a heavy part fixed to a main element arranged to connect said heavy part to an arbor integral with a movement, said main element being made of a transparent or translucent material. Such an oscillating winding weight allows the movement to which it is fitted to be observed without any visible obstacle.

However, these transparent oscillating weights are not enough for the result to be aesthetically pleasing, in particular when they are at rest.

### SUMMARY OF THE INVENTION

The aim of the present invention is to overcome the drawbacks of the prior art by proposing an oscillating winding weight for a timepiece including a particular decorative element.

To this end, the invention relates to an oscillating winding weight of a movement of a timepiece, said oscillating winding weight being intended to be mounted such that it can rotate on an arbor of the movement, said weight comprising a main element conferring the overall shape of the oscillating winding weight, a heavy part allowing the weight to oscillate in response to the movement of the timepiece and to the force of gravity

The invention is noteworthy in that it comprises a decorative element, the decorative element being a logo or initials, the decorative element being attached to the main element, the main element comprising a first material, the decorative element comprising a second material and the heavy part comprising a third material, the third material having a higher density than the second material, such that the heavy part is heavier than the decorative element in order to position it in a predefined position.

Thanks to this new winding weight structure, a decorative element is arranged on the main element of the winding weight. Thus, the winding weight has a more attractive aesthetic appearance compared to a conventional winding weight known in the prior art. More specifically, the decorative element, which can represent a logo or a brand's initials, adds to the charm of the winding weight and thus of the timepiece. The two materials being different allows the winding weight to be oriented in a specific position, when the winding weight is at rest. Thus, the logo or initials is/are in a specific position in the rest position.

According to one specific embodiment of the invention, the weight comprises an additional element forming the heavy part, the additional element being integral with the main element.

According to one specific embodiment of the invention, the additional element is an unbalance, for example formed by an arc of a circle, which is arranged at the periphery of the main element.

According to one specific embodiment of the invention, the decorative element is disposed in a position symmetrical to that of the additional element with respect to the centre of the main element.

According to one specific embodiment of the invention, the additional element is pressed into the main element, or overmoulded on the main element, or bonded to the main element.

According to one specific embodiment of the invention, the weight comprises an additional element forming the heavy part, the additional element being integral with the decorative element.

According to one specific embodiment of the invention, the heavy part comprises a weighting member arranged on the decorative element to orient the decorative element in a preferred direction when the winding weight is at rest.

According to one specific embodiment of the invention, the weighting member comprises a high-density material with a density greater than 10, for example tungsten or a tungsten alloy.

According to one specific embodiment of the invention, the additional element is pressed into the decorative element, or overmoulded on the decorative element, or bonded to the decorative element.

According to one specific embodiment of the invention, the second material has a density of less than 5, preferably less than 3 or even less than 2.

According to one specific embodiment of the invention, the second material comprises metal, for example aluminium, magnesium or titanium, preferably in its entirety.

According to one specific embodiment of the invention, the third material has a density greater than 10, preferably greater than 20.

According to one specific embodiment of the invention, the decorative element is pressed into the main element, or overmoulded on the main element, or bonded to the main element.

According to one specific embodiment of the invention, the first material is transparent, preferably made of sapphire, glass, or plastic.

The invention further relates to a timepiece including a case formed by a middle closed by a crystal and an at least partially transparent back wherein an automatic-winding horological movement is housed, said movement being fitted with an oscillating winding weight according to the invention.

### BRIEF DESCRIPTION OF THE DRAWINGS

Other details of the invention will be more clearly understood upon reading the following description, given with reference to the accompanying drawings, wherein:

FIG. 1 shows an overhead view of a first embodiment of an oscillating winding weight according to the invention; and

FIG. 2 shows an overhead view of a second embodiment of an oscillating winding weight according to the invention.

### DETAILED DESCRIPTION OF A PREFERRED EMBODIMENT

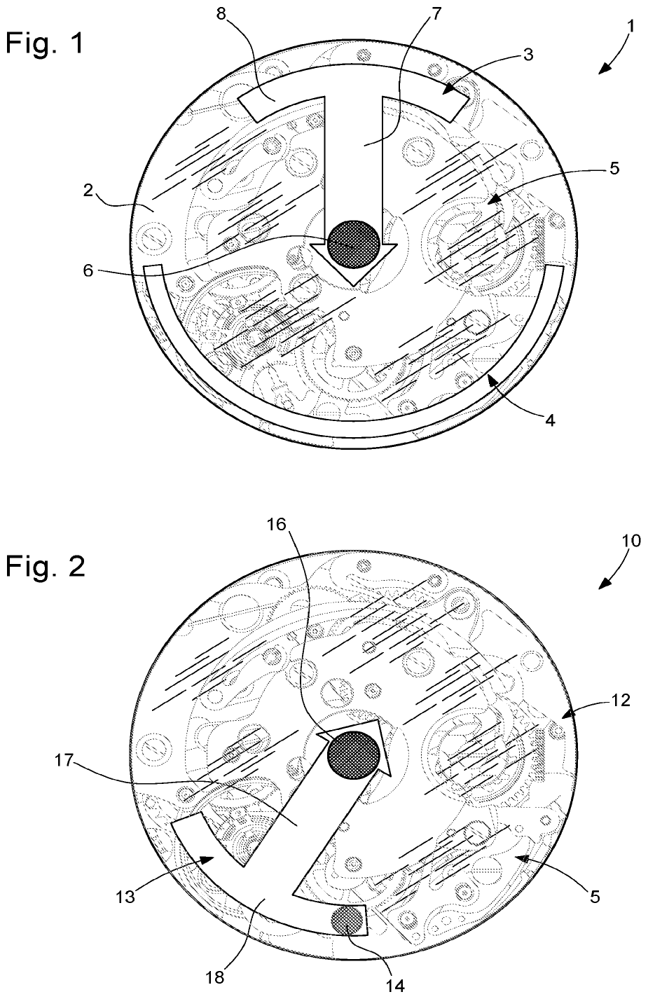

FIG. 1 shows a first embodiment of an oscillating winding weight according to the invention, designated by the general reference numeral 1. This weight 1 is intended to be fitted to the automatic-winding movement 5 of a timepiece in a conventional manner, the timepiece including in particular a case formed by a middle closed by a crystal and an at least partially transparent back in order to make the movement 5 visible from the back, and which are not shown in the figures.

The winding weight 1 comprises a main element 2 conferring the overall shape of the oscillating winding weight 1. The main element 2 is formed by a solid disc. The main element 2 is made of a first transparent material. The main element 2 is, for example, made of sapphire with a density substantially equal to 4, of glass with a density substantially equal to 2, or of plastic with a density substantially equal to 1.2. It goes without saying that any other transparent or translucent, synthetic or natural material can be used. For example, a polycarbonate suitable for this application can be used. In any case, the material must at least allow light to pass through so that the shapes of the elements behind it can be distinguished.

The main element 2 is connected to the mechanism of the movement 5 by an arbor 6 about which it can rotate. The arbor 6 passes through the centre of the disc. Thus, the main element 2 makes a circular motion about the arbor 6, when it oscillates.

A part of the winding weight forms a heavy part allowing the weight to oscillate in response to the movement of the timepiece and the force of gravity. The heavy part comprises a third material with a density greater than 10, preferably greater than or equal to 20. For example, the third material comprises tungsten or a tungsten alloy with a density substantially equal to 20, preferably in its entirety.

In the first embodiment, the oscillating weight 1 comprises an additional element 4 forming the heavy part. The additional element 4 is integral with the main element 2. In this embodiment, the additional element 4 is an arc-shaped unbalance arranged at the periphery of the disc of the main element 2. The arc of the circle forms an angle comprised between 90 and 180°, preferably comprised between 150 and 180°, which is for example substantially equal to 170°.

According to other embodiments, other geometries of the unbalance are of course possible.

According to the invention, the winding weight 1 comprises a decorative element 3, the decorative element 3 being a logo or initials, the decorative element 3 being attached to the main element 2 of the weight 1. The decorative element 3 is made of a second material that is preferably opaque in order to be seen on the transparent main element 2. In this embodiment, the second material of the decorative element 3 has a density of less than 5, preferably less than 3 or even less than 2. The second material comprises, for example, metal, preferably in its entirety, which can be titanium with a density substantially equal to 4.5, aluminium with a density substantially equal to 2.7 or magnesium with a density substantially equal to 1.7, or an alloy formed by a combination of these metals or of these metals and others. In this case, the decorative element 3 is an anchor-shaped logo with a substantially straight segment 7 and a curved segment 8, the straight segment 7 being connected to the curved segment 8 at its middle, on the internal side of the curvature. The decorative element 3 is disposed in a position symmetrical to that of the additional element 4 with respect to the centre of the main element 2. The position of the decorative element 3 is inverted with respect to the curvature of the unbalance. Thus, in the rest position, the unbalance is positioned towards the bottom of the disc, with gravity applying downwards in the figure, whereas the anchor is positioned at the top of the disc, in an inverted position, i.e. the curved segment 8 is above the straight segment 7. The rest position is understood to mean that the oscillating weight is not moving, and thus that the heavy part is positioned according to gravity. This disposition gives the oscillating winding weight an aesthetically pleasing quality when it is at rest. More specifically, the logo is positioned upside down at the top of the main element 2.

The second and third materials thus have different densities. Thus, the additional element 4 is heavier than the decorative element 3, and allows the oscillating winding weight 1 to be oriented into a specific position, when the weight 1 is at rest. More specifically, the difference in density results in a lower positioning of the additional element 4 according to the direction of gravity. This results in a predefined position of the decorative element 3. In this embodiment, this configuration allows the decorative element 3 to be placed in a preferred direction, going against the force of gravity, for example upside down as shown in FIG. 1. In other words, the decorative element 3 maintains a position with a specific orientation relative to the watch middle when the oscillating weight is at rest.

In a first alternative embodiment of the oscillating weight 1, the decorative element 3 and the additional element 4 are pressed into the main element 2. To this end, the main element 2 is recessed to form indentations into which each element 3, 4 is pressed, each indentation corresponding to the dimensions of one of the elements 3, 4.

In a second alternative embodiment of the oscillating weight 1, the decorative element 3 and the additional element 4 are overmoulded on the main element 2. The decorative element 3 and the additional element 4 are, for example, also made of transparent materials.

In a third alternative embodiment of the oscillating weight 1, the decorative element 3 and the additional element 4 are bonded to the main element 2. Indentations can also be recessed in the main element 2 to ensure a secure hold.

The second embodiment in FIG. 2 shows an oscillating winding weight 10, wherein the heavy part of the weight 10 is arranged on the decorative element 12.

The winding weight 10 comprises a main element 12 conferring the overall shape of the oscillating winding weight 10. The main element 12 is formed by a solid disc. The main element 12 is made of a first transparent material. The main element 12 is, for example, made of sapphire with a density substantially equal to 4, of glass with a density substantially equal to 2, or of plastic, such as polycarbonate, with a density substantially equal to 1.2. The main element 12 rotates about an arbor 16 of the movement 15.

According to the invention, the winding weight 10 comprises a decorative element 13, the decorative element 13 being a logo or initials, the decorative element 13 being attached to the main element 12 of the weight. In this case, the decorative element 13 is an anchor-shaped logo with a substantially straight segment 17 and a substantially curved segment 18, the straight segment 17 being connected to the curved segment 18 at its middle, on the internal side of the curvature. The decorative element 13 comprises a second material that is preferably opaque in order to be seen on the transparent main element. The second material of the decorative element 13 has a density of less than 5, preferably less than 3 or even less than 2. The second material comprises, for example, metal, preferably in its entirety, which can be titanium with a density substantially equal to 4.5, aluminium with a density substantially equal to 2.7 or magnesium with a density substantially equal to 1.7, or an alloy formed by a plurality of metals.

In this embodiment, the heavy part comprises a weighting member 14 arranged on the decorative element 13. The weighting member 14 is made of a third high-density material, preferably with a density greater than 10. The third material comprises, for example, tungsten with a density substantially equal to 20, or a tungsten alloy, preferably in its entirety.

The weighting member 14 is, for example, shaped like a ball or a cylindrical block or even a grub screw. The weighting member 14 can also be concealed in or beneath the anchor.

The weighting member 14 allows the decorative element 13 to be oriented in a preferred direction when the winding weight is at rest. As shown in FIG. 2, the weighting member 14 is disposed at one end 19 of the curved segment 18 of the anchor. Thus, the weighting member 14 weighs down one side of the decorative element 13 in order to offset the position of the decorative element when the weight 10 is in the rest position. More specifically, without the weighting member 14, the anchor would be substantially straight, whereas with the weighting member, the anchor is angularly offset by the weight of the weighting member 14. The anchor is presented in an askew position relative to the position of balance thereof, without a weighting member 14. The purpose of the weighting member 14 is to unbalance the decorative element 13 in order to orient it in a predefined position.

According to different alternatives to this embodiment, the weighting member 14 can be disposed at other locations on the decorative element 13, depending on the desired orientation thereof, when the oscillating weight 10 is at rest.

The alternative embodiments of the oscillating weight are the same as for the first embodiment, except for the weighting member 14, which is screwed, bonded, overmoulded or pressed onto the decorative element 13 instead of the main element 12.

1-15. (canceled)

16. An oscillating winding weight of a movement of a timepiece, said oscillating winding weight being configured to be mounted such that it can rotate on an arbor of the movement, said oscillating winding weight comprising:
a main element conferring an overall shape of the oscillating winding weight;
a heavy part allowing the oscillating winding weight to oscillate in response to the movement of the timepiece and to a force of gravity; and
a decorative element, the decorative element being a logo or initials, and the decorative element being attached to the main element, wherein
the main element comprises a first material,
the decorative element comprises a second material,
the heavy part comprises a third material, and
the third material has a higher density than the second material, such that the heavy part is heavier than the decorative element in order to position the decorative element in a predefined position.

17. The oscillating winding weight according to claim 16, further comprising an additional element forming the heavy part, the additional element being integral with the main element.

18. The oscillating winding weight according to claim 16, wherein an additional element is an unbalance, in a shape of an arc of a circle, which is arranged at the periphery of the main element.

19. The oscillating winding weight according to claim 16, wherein the decorative element is disposed in a position symmetrical to a position of an additional element with respect to a center of the main element.

20. The oscillating winding weight according to claim 18, wherein the additional element is pressed into the main element, overmoulded on the main element, or bonded to the main element.

21. The oscillating winding weight according to claim 16, further comprising an additional element forming the heavy part, the additional element being integral with the decorative element.

22. The oscillating winding weight according to claim 21, wherein the heavy part comprises a weighting member arranged on the decorative element to orient the decorative element in a preferred direction when the winding weight is at rest.

23. The oscillating winding weight according to claim 22, wherein the weighting member comprises a high-density material with a density greater than 10.

24. The oscillating winding weight according to claim 21, wherein the additional element is pressed into the decorative element, overmoulded on the decorative element, or bonded to the decorative element.

25. The oscillating winding weight according to claim 16, wherein the second material has a density of less than 5.

26. The oscillating winding weight according to claim 25, wherein the second material has a density of less than 3.

27. The oscillating winding weight according to claim 26, wherein the second material has a density of less than 2.

28. The oscillating winding weight according to claim 16, wherein the second material comprises metal, including aluminum, magnesium or titanium.

29. The oscillating winding weight according to claim 28, wherein the second material comprises the metal in its entirety.

30. The oscillating winding weight according to claim 16, wherein the third material has a density greater than 10.

31. The oscillating winding weight according to claim 16, wherein the third material has a density greater than 20.

32. The oscillating winding weight according to claim 16, wherein the decorative element is pressed into the main element, overmoulded on the main element, or bonded to the main element.

33. The oscillating winding weight according to claim 16, wherein the first material is transparent.

34. The oscillating winding weight according to claim 16, wherein the first material is made of sapphire, glass, or plastic.

35. A timepiece including a case formed by a middle closed by a crystal and an at least partially transparent back wherein an automatic-winding horological movement is housed, wherein said movement is fitted with the oscillating winding weight according to claim 16.
